(19) United States
(12) Patent Application Publication
(10) Pub. No.: US 2025/0079452 A1
(43) Pub. Date: Mar. 6, 2025

(54) SECONDARY BATTERY ELECTRODE AND SECONDARY BATTERY

(71) Applicant: HONDA MOTOR CO., LTD., Tokyo (JP)

(72) Inventors: Noriaki KAMAYA, Saitama (JP); Hiroto MAEYAMA, Saitama (JP); Soshi KAWAMURA, Saitama (JP); Yusuke YOSHIZAKI, Saitama (JP)

(21) Appl. No.: 18/822,474

(22) Filed: Sep. 3, 2024

(30) Foreign Application Priority Data
Sep. 6, 2023 (JP) 2023-144534

(51) Int. Cl. H01M 4/36; H01M 4/02

(52) U.S. Cl. CPC H01M 4/366; H01M 2004/021; H01M 2004/028

(57) ABSTRACT

A secondary battery electrode according to an embodiment of the present invention includes: a current collector; and an active material layer disposed on at least one surface of the current collector, the active material layer contains an active material and a conductive aid, an average value of areas of Voronoi regions obtained by performing Voronoi analysis on an image of a cross section using the conductive aid as a generatrix is within a range of 1.00 μm² or more and 2.50 μm² or less, a standard deviation of the areas of the Voronoi regions is 0.20 or less.

This application is based on and claims the benefit of priority from Japanese Patent Application No. 2023-144534, filed on 6 Sep. 2023, the content of which is incorporated herein by reference.

### BACKGROUND OF THE INVENTION

### Field of the Invention

The present invention relates to a secondary battery electrode and a secondary battery.

### Related Art

In recent years, research and development related to a secondary battery that contributes to energy efficiency have been performed in order to ensure that more people have access to handy, reliable, sustainable, and advanced energy. An electrode of a secondary battery generally includes a current collector and an active material layer capable of absorbing and releasing ions (a charge carrier) such as lithium ions. A coating method is known as a method of producing the active material layer. The coating method is a method in which an active material layer-forming slurry obtained by dispersing constituent materials such as an active material, a conductive aid, and optionally a solid electrolyte, a binder, and a dispersant in a solvent is coated on the current collector and dried.

In order to improve a characteristic of the active material layer produced by the coating method, a material and a composition of the active material layer-forming slurry have been studied. For example, it has been studied to use two or more kinds of solvents in order to sufficiently enhance binding force of the active material layer to the current collector while achieving good dispersibility of the active material and the solid electrolyte in the active material layer-forming slurry (Patent Document 1). It has been studied to use a predetermined binder in order to reduce aggregation of the conductive aid in the active material layer-forming slurry and improve dispersibility of the conductive aid (Patent Document 2).
Patent Document 1: Japanese Unexamined Patent Application, Publication No. 2015-82362
Patent Document 2: Japanese Unexamined Patent Application, Publication No. 2015-50017

### SUMMARY OF THE INVENTION

Incidentally, in a technique related to the secondary battery, one of the challenges is increasing an operating voltage at a high current density. In order to increase the high potential of the operating voltage at the high current density, it is effective to reduce ion diffusion resistance of the active material layer of the electrode to facilitate diffusion of ions in the active material layer. Uniformly dispersing materials such as the active material and the conductive aid in the active material layer is considered to be one effective means for reducing the ion diffusion resistance of the active material layer. However, according to the study of the present inventors, the conventional active material layer may have insufficient material dispersibility, and the operating voltage at the high current density may be greatly reduced.

The present invention has been made in view of the above problems, and an object thereof is to provide a secondary battery electrode having an active material layer in which materials such as an active material and a conductive aid are uniformly dispersed and ion diffusion resistance is low, and a secondary battery having a high operating voltage at a high current density. Further, the present invention contributes to energy efficiency.

The present inventors have found that dispersibility (uniformity) of an active material layer can be appropriately understood by using an area of a Voronoi region obtained by performing Voronoi analysis using a conductive aid as a generatrix on an image of a cross section of the active material layer and a standard deviation of the areas of the Voronoi regions. Then, it was confirmed that an electrode having an active material layer in which an average value of the areas of the Voronoi regions and an average value of the standard deviation of the areas of the Voronoi regions have a predetermined value has reduced diffusion resistance, and a secondary battery using this electrode has a high potential operating voltage at a high current density, and the present invention was thus made. Therefore, the present invention provides the following.

A first aspect of the present disclosure relates to a secondary battery electrode including: a current collector; and an active material layer disposed on at least one surface of the current collector, the active material layer containing an active material and a conductive aid, an average value of areas of Voronoi regions obtained by performing Voronoi analysis on an image of a cross section using the conductive aid as a generatrix being within a range of 1.00 μm² or more and 2.50 μm² or less, a standard deviation of the areas of the Voronoi regions being 0.20 or less.

According to the secondary battery electrode of the first aspect, since the average value and the standard deviation of the areas of the Voronoi regions obtained by performing the Voronoi analysis using the conductive aid as the generatrix are within the above range, and the conductive aid is uniformly dispersed in the active material layer, the electrical conductivity of the active material layer becomes uniform. Therefore, ions are easily diffused in the entire active material layer, and ion diffusion resistance in the active material layer is reduced.

A second aspect of the present disclosure relates to the secondary battery electrode as described in the first aspect, in which a variation coefficient of the areas of the Voronoi regions is 10.0% or less.

According to the secondary battery electrode of the second aspect, since the variation coefficient of the areas of the Voronoi regions is within the above range, the ion diffusion resistance of the active material layer is further reduced.

A third aspect of the present disclosure relates to the secondary battery electrode as described in the first or second aspect, in which the conductive aid has a spherical shape, and a ratio of an average particle diameter of the conductive aid measured by a laser diffraction method to an average particle diameter of the active material measured by the laser diffraction method is in a range of 0.010 or more and 0.080 or less.

According to the secondary battery electrode of the third aspect, since the conductive aid has a spherical shape and is finer than the active material, and the conductive aid is easily uniformly dispersed in the active material layer, the ion diffusion resistance of the active material layer is further reduced.

A fourth aspect of the present disclosure relates to the secondary battery electrode as described in any one of the first to third aspects, further including: a solid electrolyte, in which a ratio of an average particle diameter of the solid electrolyte measured by a laser diffraction method to an average particle diameter of the active material measured by the laser diffraction method is in a range of 0.10 or more and 0.90 or less.

According to the secondary battery electrode of the fourth aspect, since the secondary battery electrode contains a fine solid electrolyte as compared with the active material, the ion diffusion resistance in the active material layer is further reduced. Therefore, the secondary battery electrode of the fourth aspect is useful as an electrode for a solid-state battery.

A fifth aspect of the present disclosure relates to the secondary battery electrode as described in any one of the first to fourth aspects, in which an average particle diameter of the active material measured by a laser diffraction method is in a range of 1.0 μm or more and 5.0 μm or less.

According to the secondary battery electrode of the fifth aspect, since the average particle diameter of the active material is as fine as within the above range, and a surface area of the active material is increased, the ion diffusion resistance of the active material layer is further reduced.

A sixth aspect of the secondary battery electrode as described in any one of the first to fifth aspects, in which the secondary battery electrode is used as a positive electrode of a secondary battery.

The secondary battery electrode of the sixth aspect is useful as a positive electrode of a solid-state battery or a nonaqueous solvent secondary battery.

A seventh aspect of the present disclosure relates to a secondary battery including: the secondary battery electrode as described in any one of the first to sixth aspects).

According to the secondary battery of the seventh aspect, since the above secondary battery electrode is provided, decrease in an operating voltage at a high current density is reduced, and the operating voltage at the high current density is increased.

According to the present invention, it is possible to provide a secondary battery electrode having an active material layer in which materials such as an active material and a conductive aid are uniformly dispersed and ion diffusion resistance is low, and a secondary battery having a high operating voltage at a high current density.

### BRIEF DESCRIPTION OF THE DRAWINGS

FIG. 1 is a cross-sectional view illustrating a secondary battery according to an embodiment of the present invention;

FIG. 2 is a schematic diagram illustrating an example of a Voronoi diagram obtained by performing Voronoi analysis on a cross section of a positive electrode active material layer of the secondary battery according to the embodiment of the present invention, the Voronoi diagram using a conductive aid as a generatrix;

FIG. 3A is a secondary electron image of the cross section of the positive electrode active material layer obtained in Example 1;

FIG. 3B is a Voronoi diagram of a cross section of a positive electrode active material obtained in Example 1, the Voronoi diagram using the conductive aid as the generatrix;

FIG. 4A is a frequency distribution of an average area of Voronoi regions measured at 30 positions in the cross section of the positive electrode active material layer obtained in Example 1;

FIG. 4B is a frequency distribution of an average area of Voronoi regions measured at 30 positions in a cross section of a positive electrode active material layer obtained in Example 2;

FIG. 4C is a frequency distribution of an average area of Voronoi regions measured at 30 positions in a cross section of a positive electrode active material layer obtained in Example 3;

FIG. 4D is a frequency distribution of an average area of Voronoi regions measured at 30 positions in a cross section of a positive electrode active material layer obtained in Example 4;

FIG. 4E is a frequency distribution of an average area of Voronoi regions measured at 30 positions in a cross section of a positive electrode active material layer obtained in Comparative Example 1;

FIG. 4F is a frequency distribution of an average area of Voronoi regions measured at 30 positions in a cross section of a positive electrode active material layer obtained in Comparative Example 2;

FIG. 4G is a frequency distribution of an average area of Voronoi regions measured at 30 positions in a cross section of a positive electrode active material layer obtained in Comparative Example 3; and

FIG. 5 is an I-V characteristic graph of solid-state batteries produced using positive electrodes obtained in Examples 1 to 4 and Comparative Examples 1 to 3.

### DETAILED DESCRIPTION OF THE INVENTION

Hereinafter, a secondary battery electrode and a secondary battery using the electrode according to an embodiment of the present invention will be described in detail with reference to the drawings, but the present invention is not limited thereto.

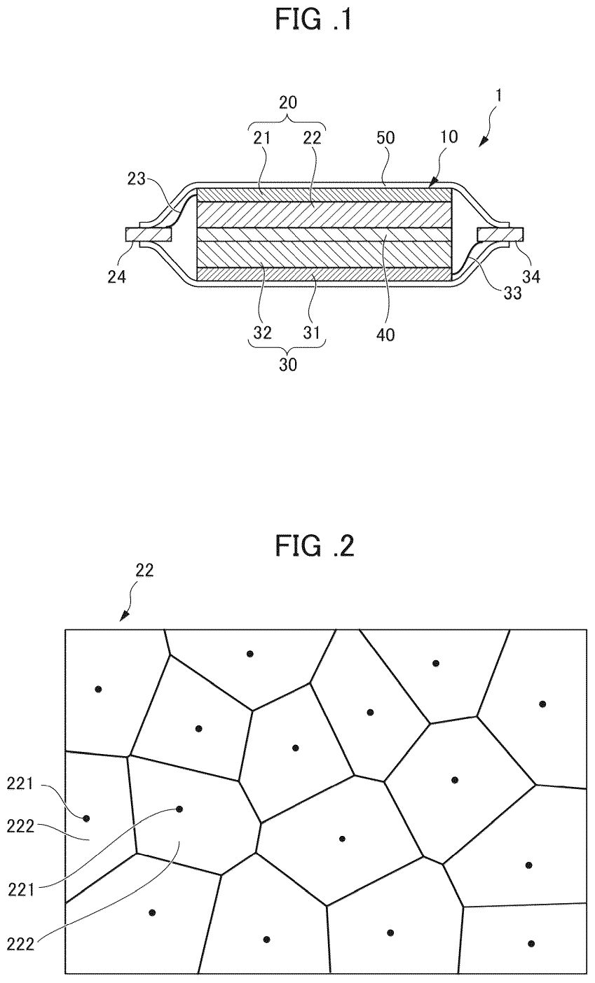

FIG. 1 is a cross-sectional view illustrating a secondary battery according to an embodiment of the present invention. FIG. 2 is a schematic diagram illustrating an example of a Voronoi diagram obtained by performing Voronoi analysis on a cross section of a positive electrode active material layer of the secondary battery according to the embodiment of the present invention, the Voronoi diagram using a conductive aid as a generatrix.

As illustrated in FIG. 1, a secondary battery 1 of the present embodiment is a solid-state battery including an electrode laminate 10 and an outer case 50 that accommodates the electrode laminate 10. The electrode laminate 10 is a laminate in which a positive electrode 20 and a negative electrode 30 are laminated via a solid electrolyte layer 40. The positive electrode 20 includes a positive electrode current collector 21 and a positive electrode active material layer 22 disposed on a surface of the positive electrode current collector 21 on the solid electrolyte layer 40 side. The positive electrode current collector 21 is connected to a positive electrode terminal 24 via a positive electrode lead wire 23. The negative electrode 30 includes a negative electrode current collector 31 and a negative electrode active material layer 32 disposed on a surface of the negative electrode current collector 31 on the solid electrolyte layer 40 side. The negative electrode current collector 31 is connected to a negative electrode terminal 34 via a negative electrode lead wire 33. The positive electrode terminal 24 and the negative electrode terminal 34 are partially exposed from the outer case 50.

A material and a shape of the positive electrode current collector 21 are not particularly limited as long as the positive electrode current collector 21 has a function of collecting current of the positive electrode 20. Examples of the material for the positive electrode current collector 21 include aluminum, aluminum alloy, stainless steel, nickel, iron, and titanium, and among them, the aluminum, the aluminum alloy, and the stainless steel are preferable. Examples of the shape of the positive electrode current collector 21 include a foil shape and a plate shape.

As illustrated in FIG. 2, in the positive electrode active material layer 22, in a Voronoi diagram obtained by performing Voronoi analysis using a conductive aid 221 as a generatrix, an average value of areas of the Voronoi regions 222 is within a range of 1.00 μm² or more and 2.50 μm² or less, and a standard deviation of the areas of the Voronoi regions 222 is 0.20 or less. The average value of the areas of the Voronoi regions 222 indicates a distance between the conductive aid 221 and the conductive aid 221. The standard deviation of the areas of the Voronoi regions 222 indicates a variation in the distance between the conductive aid 221 and the conductive aid 221. Therefore, when the average value and the standard deviation of the areas of the Voronoi regions 222 are within the above ranges, the conductive aid 221 is uniformly dispersed in the positive electrode active material layer 22. The average value of the areas of the Voronoi regions 222 may be within a range of 1.50 μm² or more and 2.00 μm² or less. The standard deviation of the areas of the Voronoi regions 222 may be within a range of 0.05 or more and 0.20 or less. A variation coefficient of the areas of the Voronoi regions 222 may be 10.0% or less, or may be within a range of 1.0% or more and 9.0% or less.

The Voronoi diagram can be obtained as follows, for example. An electron reflection image is obtained using a scanning electron microscope (SEM) for a cross section of the positive electrode active material layer 22. The obtained electron reflection image is binarized in a region of the conductive aid in which electrons are not reflected and the other region in which electrons are reflected. A Voronoi diagram is obtained by performing Voronoi analysis using the region of the conductive aid of the obtained binarized image as a generatrix.

The positive electrode active material layer 22 contains at least one positive electrode active material and a conductive aid. The positive electrode active material is not particularly limited, and for example, a layered active material, a spinel-type active material, an olivine-type active material, and the like which contain lithium can be used. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), heterogeneous element-substituted Li—Mn spinel represented by Liₗ₊ₓMn_{2-x-y}MO₄ (x+y=2, M=at least one selected from Al, Mg, Co, Fe, Ni, or Zn), lithium titanate (oxides containing Li and Ti), and lithium metal phosphate (LiMPO₄, M=at least one selected from Fe, Mn, Co, or Ni).

A shape of the positive electrode active material may have, for example, a spherical shape, a polygonal shape, or an amorphous shape. The spherical shape does not have to be a true spherical shape, and only needs to have an aspect ratio of 2 or less. The positive electrode active material may have an average particle diameter (D50) in a range of 1.0 μm or more and 6.5 μm or less. In addition, the positive electrode active material may have a particle diameter (D90) at which cumulative particle size distribution under a sieve is 90% within a range of 5.5 μm or more and 10.0 μm or less. Further, a ratio D90/D50 of D90 to D50 of the positive electrode active material may be in a range of 1.3 or more and 1.9 or less. In the present embodiment, the particle diameter is a value measured by a laser diffraction method.

The conductive aid is not particularly limited, and for example, conductive carbon can be used. A shape of the conductive aid may be, for example, spherical. Carbon black can be used as the spherical conductive carbon. An average particle diameter of the conductive aid may be in a range of 0.010 or more and 0.080 or less as a ratio of an average particle diameter of the conductive aid to an average particle diameter of the active material (average particle diameter of the conductive aid/average particle diameter of the active material). The average particle diameter (D50) of the conductive aid may be in a range of 0.010 μm or more and 0.50 μm or less. The conductive aid may have a particle diameter (D90) at which the cumulative particle size distribution under the sieve is 90% within a range of 0.3 μm or more and 1.0 μm or less. Further, a ratio D90/D50 of D90 to D50 of the conductive aid may be in a range of 0.6 or more and 100 or less.

The positive electrode active material layer 22 may further contain a solid electrolyte, a binder, and a dispersant.

As the solid electrolyte, those used in the solid electrolyte layer 40 can be used. The solid electrolyte contained in the positive electrode active material layer 22 may have, for example, a spherical shape, a polygonal shape, or an amorphous shape. An average particle diameter of the solid electrolyte may be in a range of 0.10 or more and 0.90 or less as a ratio of the average particle diameter of the solid electrolyte to the average particle diameter of the active material (average particle diameter of the solid electrolyte/average particle diameter of the active material). The average particle diameter (D50) of the solid electrolyte may be in a range of 0.50 μm or more and 1.5 μm or less. In addition, the solid electrolyte may have a particle diameter (D90) at which the cumulative particle size distribution under the sieve is 90% within a range of 1.5 μm or more and 3.0 μm or less. Further, a ratio D90/D50 of D90 to D50 of the solid electrolyte may be in a range of 1.0 or more and 4.5 or less. A part or all of the solid electrolyte contained in the positive electrode active material layer 22 may be coated on a surface of the positive electrode active material.

The binder is not particularly limited, and for example, a fluororesin or rubber can be used. Examples of the fluororesin include polyvinylidene fluoride (PVDF) and polytetrafluoroethylene (PTFE). Examples of the rubber include styrene butadiene rubber (SBR) and ethylene propylene diene rubber (EPDM).

The dispersant is not particularly limited, and for example, polyvinyl butyral, polyvinyl pyrrolidone, and carboxymethyl cellulose can be used.

A content of each material of the positive electrode active material layer 22 may be, for example, as follows, when a total weight is 100% by mass: a content of the active material is in a range of 50% by mass or more and 90% by mass or less, a content of the conductive aid is in a range of 10% by mass or more and 50% by mass or less, a content of the solid electrolyte is in a range of 0% by mass or more and 40% by mass or less, a content of the binder is in a range of 0% by mass or more and 5% by mass or less, and a content of the dispersant is in a range of 0% by mass or more and 1% by mass or less. The content of the solid electrolyte may be in a range of 5% by mass or more and 40% by mass or less, the content of the binder may be in a range of 1% by mass or more and 5% by mass or less, and the content of the dispersant may be in a range of 0.05% by mass or more and 18 by mass or less.

The positive electrode active material layer 22 can be produced by applying a positive electrode active material layer-forming slurry to a surface of the positive electrode current collector 21 and drying the slurry. The positive electrode active material layer-forming slurry can be produced, for example, as follows. First, a binder containing liquid is produced. The binder containing liquid can be obtained by dissolving or dispersing a binder in a solvent. As the solvent, an ester-based solvent can be used. Examples of the ester-based solvent include butyl butyrate. Next, the conductive aid and the dispersant are added to and mixed with the binder containing liquid. Next, the active material and the solid electrolyte are added to and mixed with the binder containing liquid to which the conductive aid and the dispersant are added. For mixing, for example, a ball mill can be used.

A material of the positive electrode lead wire 23 may be the same as or different from a material of the positive electrode current collector 21. The positive electrode lead wire 23 may be integrally connected to the positive electrode current collector 21. A material of the positive electrode terminal 24 may be the same as or different from a material of the positive electrode lead wire 23. The positive electrode terminal 24 may be integrally connected to the positive electrode lead wire 23.

A material and a shape of the negative electrode current collector 31 are not particularly limited as long as the negative electrode current collector 31 has a function of collecting current of the negative electrode 30. Examples of the material of the negative electrode current collector 31 include nickel, copper, and stainless steel. Examples of the shape of the negative electrode current collector 31 include a foil shape and a plate shape.

The negative electrode active material layer 32 contains at least one negative electrode active material. As the negative electrode active material, a material capable of absorbing and releasing lithium ions, or a metal forming an alloy with lithium can be used. As the material capable of absorbing and releasing the lithium ions, for example, lithium transition metal oxides such as lithium titanate (Li₄Ti₅O₁₂), transition metal oxides such as TiO₂, Nb₂O₃ and WO₃, metal sulfides, metal nitrides, graphite, carbon materials such as soft carbon and hard carbon can be used. As the metal that forms an alloy with lithium, for example, Mg, Si, Au, Ag, In, Ge, Sn, Pb, Al, and Zn can be used.

A shape of the negative electrode active material may have, for example, a spherical shape, a polygonal shape, or an amorphous shape. The negative electrode active material may have an average particle diameter (D50) in a range of 1.0 μm or more and 5.0 μm or less. In addition, the negative electrode active material may have a particle diameter (D90) at which cumulative particle size distribution under a sieve is 90% within a range of 5.5 μm or more and 7.0 μm or less. Further, a ratio D90/D50 of D90 to D50 of the negative electrode active material may be in a range of 1.3 or more and 1.9 or less.

The negative electrode active material layer 32 may further contain the conductive aid, the solid electrolyte, the binder, and the dispersant. The conductive aid, the solid electrolyte, the binder, and the dispersant may be the same as those exemplified for the positive electrode active material layer 22.

A material of the negative electrode lead wire 33 may be the same as or different from the material of the negative electrode current collector 31. The negative electrode lead wire 33 may be integrally connected to the negative electrode current collector 31. A material of the negative electrode terminal 34 may be the same as or different from the material of the negative electrode lead wire 33. The negative electrode terminal 34 may be integrally connected to the negative electrode lead wire 33.

The solid electrolyte layer 40 contains at least one solid electrolyte material. As the solid electrolyte material, a sulfide solid electrolyte material, an oxide solid electrolyte material, a nitride solid electrolyte material, and a halogenated solid electrolyte material can be used.

Examples of the sulfide solid electrolyte material include Li₂S—P₂S₅, Li₂S—P₂S₅—LiI, Li₆PS₅Cl, and Li₃PS₄. The description of “Li₂S—P₂S₅” means a sulfide solid electrolyte material formed using a raw material composition containing Li₂S and P₂S₅, and the same applies to other descriptions. The sulfide solid electrolyte material may have an argyrodite-type crystal structure.

Examples of the oxide solid electrolyte material include a NASICON-type oxide, a garnet-type oxide, and a perovskite oxide. Examples of the NASICON-type oxide include an oxide containing Li, Al, Ti, P, and O (for example, Li_{1.5}Al_{0.5}Ti_{1.5} (PO₄)₃). Examples of the garnet-type oxide include an oxide containing Li, La, Zr, and O (for example, Li₂La₃Zr₂O₁₂). Examples of the perovskite oxide include an oxide containing Li, La, Ti, and O (for example, LiLaTiO₃).

The solid electrolyte contained in the solid electrolyte layer 40 may have, for example, a spherical shape, a polygonal shape, or an amorphous shape. The average particle diameter (D50) of the solid electrolyte may be in a range of 3.0 μm or more and 5.0 μm or less. In addition, the solid electrolyte may have a particle diameter (D90) at which the cumulative particle size distribution under the sieve is 90% within a range of 5.0 μm or more and 10.0 μm or less. Further, the ratio D90/D50 of D90 to D50 of the solid electrolyte may be in a range of 1.5 or more and 3.5 or less.

As a material of the outer case 50, for example, a laminated film can be used. As the laminated film, a laminate film having a three-layer structure in which an inner resin layer, a metal layer, and an outer resin layer are laminated in this order from the inside can be used. The outer resin layer may be, for example, a polyamide (nylon) layer or a polyethylene terephthalate (PET) layer, the metal layer may be, for example, an aluminum layer, and the inner resin layer may be, for example, a polyethylene layer or a polypropylene layer.

The secondary battery 1 of the present embodiment can be produced, for example, as follows. First, the positive electrode 20, the solid electrolyte layer 40, and the negative electrode 30 are laminated in this order, and the obtained laminate is press-bonded to obtain the electrode laminate 10. The electrode laminate 10 may be pressed in a lamination direction to improve adhesion between the positive electrode 20, the solid electrolyte layer 40, and the negative electrode 30 and increase densities of the positive electrode active material layer 22 and the negative electrode active material layer 32. Next, the positive electrode terminal 24 is connected to the positive electrode current collector 21 of the electrode laminate 10 via the positive electrode lead wire 23, and the negative electrode terminal 34 is connected to the negative electrode current collector 31 via the negative electrode lead wire 33. Next, the electrode laminate 10 is accommodated in the outer case 50, and the outer case 50 is sealed.

According to the secondary battery 1 of the present embodiment configured as described above, since the average value and the standard deviation of the areas of the Voronoi regions 222 obtained by performing the Voronoi analysis using the conductive aid 221 as a generatrix on an image of a cross section of the positive electrode active material layer 22 are within the above ranges, and the conductive aid is uniformly dispersed in the positive electrode active material layer 22, electrical conductivity of the positive electrode active material layer 22 becomes uniform. Therefore, ions are easily diffused in the entire positive electrode active material layer 22, and ion diffusion resistance of the positive electrode active material layer 22 is reduced. Accordingly, an operating voltage of the secondary battery 1 at a high current density becomes high potential.

In the secondary battery 1 of the present embodiment, when the variation coefficient of the areas of the Voronoi regions 222 is within the above range, since the ion diffusion resistance of the positive electrode active material layer 22 is further reduced, the operating voltage of the secondary battery 1 at a high current density increases. In the secondary battery 1 of the present embodiment, when a conductive aid of the positive electrode active material layer 22 has a spherical shape, and a ratio of the average particle diameter of the conductive aid to an average particle diameter of the positive electrode active material (average particle diameter of the conductive aid/average particle diameter of the positive electrode active material) is within the above range, the conductive aid can be more uniformly dispersed in the positive electrode active material layer 22, and the ion diffusion resistance of the positive electrode active material layer 22 is further reduced. Therefore, the operating voltage of the secondary battery 1 at a high current density further increases. In the secondary battery 1 of the present embodiment, when the positive electrode active material layer 22 further contains the solid electrolyte, and a ratio of the average particle diameter of the solid electrolyte to the average particle diameter of the positive electrode active material (average particle diameter of the solid electrolyte/average particle diameter of the positive electrode active material) is within the above range, the ion diffusion resistance of the positive electrode active material layer 22 is further reduced. Therefore, the operating voltage of the secondary battery 1 at a high current density further increases. In the secondary battery 1 of the present embodiment, when the average particle diameter of the positive electrode active material is as fine as within the above range, a surface area of the active material is increased, and ion diffusion resistance of the positive electrode active material layer is further reduced. Therefore, the operating voltage of the secondary battery 1 at a high current density further increases.

Although the embodiment of the present invention has been described above, the present invention is not limited to the above embodiment. For example, in the secondary battery 1 of the present embodiment, the average value of the areas of the Voronoi regions using the conductive aid of the positive electrode active material layer 22 as the generatrix and the standard deviation of the areas of the Voronoi regions are within the above ranges, but a configuration of the electrode is not limited thereto. For example, when the negative electrode active material layer 32 contains the negative electrode active material and the conductive aid, the average value of the areas of the Voronoi regions and the standard deviation of the areas of the Voronoi regions obtained by performing Voronoi analysis using the conductive aid as a generatrix on an image of a cross section of the negative electrode active material layer 32 may be within the above ranges.

In addition, in the secondary battery 1 of the present embodiment, the negative electrode active material layer 32 is disposed on a surface of the negative electrode current collector 31 of the negative electrode 30, and the negative electrode active material layer 32 is configured such that lithium ions are absorbed in the negative electrode active material during charging and lithium ions are released from the negative electrode active material during discharging, but a configuration of the negative electrode 30 is not limited thereto. The negative electrode active material layer 32 may not be disposed, and may be configured such that lithium ions are deposited on the surface of the negative electrode current collector 31 during charging and lithium ions are released from the deposited lithium during discharging. In this configuration, in order to facilitate the deposition of lithium ions on the surface of the negative electrode current collector 31 during charging, a lithium foil may be disposed on the surface of the negative electrode current collector 31.

Further, the secondary battery 1 of the present embodiment is a solid-state battery, but may be a nonaqueous solvent battery. In a case of the nonaqueous solvent battery, an electrolytic solution is not particularly limited, and various electrolytic solutions used in the nonaqueous solvent battery can be used.

### EXAMPLES

### Example 1

### (1) Production of Coated Positive Electrode Active Material

As a positive electrode active material, Li(NiCoMn)ₓO₂ (x=0.33) (D50: 3.4 μm, D90: 5.3 μm, D90/D50: 1.56) was prepared. As a solid electrolyte, Li₆PS₅Cl (D50: 0.6 μm, D90: 1.5 μm, D90/D50: 2.5) was prepared. The positive electrode active material and the solid electrolyte were mixed at a mass ratio of 90:10 to produce a coated positive electrode active material in which a surface of the positive electrode active material was coated with the solid electrolyte.

### (2) Production of Positive Electrode Active Material Layer-Forming Slurry

An SBR (styrene butadiene rubber) binder was dissolved in a butyl butyrate solvent to produce an SBR binder solution having a concentration of 10% by mass. 2.63 g of the obtained SBR binder solution was weighed, and 4.31 g of butyl butyrate solvent, 0.79 g of carbon black (spherical carbon, average diameter: 0.1 μm) as a conductive aid, and 0.05 g of PVB (polyvinyl butyral) as a dispersant were added to the SBR binder solution. The obtained mixed solution was subjected once to a first dispersion treatment in which the mixed solution was kneaded at 2000 rpm for 10 minutes using a planetary centrifugal mixer (Awatori Rentaro ARE 310, manufactured by Thinky Corporation).

To the mixed solution after the first dispersion treatment, 47.6 g of zirconia balls (diameter: 2 mm) and 33.3 g of the coated positive electrode active material obtained in the above (1) were added, and then 1.9 g of a butyl butyrate solvent was added so that a solid content ratio in the mixed solution became 80.1% by mass. Thereafter, the mixed solution was subjected to a second dispersion treatment twice in which the mixed solution was kneaded at 2000 rpm for 1 minute using the planetary centrifugal mixer.

To the mixed solution after the second dispersion treatment, 3.06 g of the solid electrolyte prepared in the above (1) was added such that a content of the positive electrode active material was adjusted to 80.0% by mass, a content of the solid electrolyte was adjusted to 17.1% by mass, a content of the conductive aid was adjusted to 2.1% by mass, a content of the binder was adjusted to 0.7% by mass, and a content of the dispersant was adjusted to 0.1% by mass. Next, 1.4 g of a butyl butyrate solvent was added so that a solid content ratio in the mixed solution was 79.0% by mass. Thereafter, the mixed solution was subjected to a third dispersion treatment once in which the mixed solution was kneaded at 2000 rpm for 2 minutes using the planetary centrifugal mixer.

To the mixed solution after the third dispersion treatment, 4.6 g of a butyl butyrate solvent was added so that a solid content ratio in the mixed solution was 72.0% by mass.

Thereafter, the mixed solution was subjected to a fourth dispersion treatment once in which the mixed solution was kneaded at 2000 rpm for 2 minutes using the planetary centrifugal mixer.

To the mixed solution after the fourth dispersion treatment, 0.9 g of a butyl butyrate solvent was added so that a solid content ratio in the mixed solution was 70.8% by mass. Thereafter, the mixed solution was subjected to a fifth dispersion treatment once in which the mixed solution was kneaded at 2000 rpm for 2 minutes using the planetary centrifugal mixer.

The mixed solution after the fifth dispersion treatment was filtered using a mesh sieve with an opening of 100 μm to remove zirconia balls. The obtained filtrate was used as the positive electrode active material layer-forming slurry.

### (3) Production of Positive Electrode

An Al current collector foil was prepared as a positive electrode current collector. The positive electrode active material layer-forming slurry obtained in the above (2) was applied to a surface of the positive electrode current collector and dried to form a positive electrode active material layer. The obtained positive electrode active material layer was pressurized at a pressure of 10 ton/cm².

### Example 2

A positive electrode was produced in the same manner as in Example 1, except that Li₆PS₅Cl (D50: 1.0 μm, D90: 3.0 μm, D90/D50: 3.0) was used as the solid electrolyte in the production of the coated positive electrode active material in (1) and the production of the positive electrode active material layer-forming slurry in (2).

### Example 3

A positive electrode was produced in the same manner as in Example 1, except that Li₆PS₅Cl (D50: 3.0 μm, D90: 8.0 μm, D90/D50: 2.7) was used as the solid electrolyte in the production of the coated positive electrode active material in (1) and the production of the positive electrode active material layer-forming slurry in (2), and the solid electrolyte was added to the mixed solution such that the content of the positive electrode active material was 60.0% by mass, the content of the solid electrolyte was 36.0% by mass, the content of the conductive aid was 2.8% by mass, the content of the binder was 1.0% by mass, and the content of the dispersant was 0.2% by mass in the production of the positive electrode active material layer-forming slurry in (2).

### Example 4

A positive electrode was produced in the same manner as in Example 1 except that, in the production of the positive electrode active material layer-forming slurry in (2), instead of the SBR binder solution, a PVdF binder dispersion solution having a concentration of 10% by mass in which a PVDF (polyvinylidene fluoride) binder was dispersed in a butyl butyrate solvent was used.

### Comparative Example 1

A positive electrode was produced in the same manner as in Example 1, except that Li₆PS₅Cl (D50: 3.0 μm, D90: 8.0 μm, D90/D50: 2.7) was used as the solid electrolyte in the production of the coated positive electrode active material in (1) and the production of the positive electrode active material layer-forming slurry in (2).

### Comparative Example 2

A positive electrode was produced in the same manner as in Example 1, except that a multilayered carbon nanotube (fibrous carbon, average diameter in a longitudinal direction: 1.0 μm) was used as a conductive aid in the production of the positive electrode active material layer-forming slurry in (2).

### Comparative Example 3

A positive electrode was produced in the same manner as in Example 1, except that Li₃PS₄ (D50: 1.1 μm, D90: 15.0 μm, D90/D50: 13.6) was used as the solid electrolyte in the production of the coated positive electrode active material in (1) and the production of the positive electrode active material layer-forming slurry in (2).

### (Components of Positive Electrode Active Material Layer)

Compositions of the positive electrode active material layer of the positive electrode obtained as described above and a particle diameter of each material are summarized.

TABLE 1

| | Positive | | | | | | | | | | |
|---|---|---|---|---|---|---|---|---|---|---|---|
| | electrode | | Solid | | | | | | | | |
| | active material | | electrolyte | | | Conductive aid | | | Binder | | Content of |
| | D50 | Content | D50 | D90/D50 | Content | | D50 | Content | | Content | dispersant |
| | (μm) | (mass %) | (μm) | (—) | (mass %) | Type | (μm) | (mass % ) | Type | (mass %) | (mass %) |
| Example 1 | 3.4 | 80.0 | 0.6 | 2.5 | 17.1 | Spherical | 0.1 | 2.1 | SBR | 0.7 | 0.1 |
| | | | | | | carbon | | | | | |
| Example 2 | 3.4 | 80.0 | 1.0 | 3.0 | 17.1 | Spherical | 0.1 | 2.1 | SBR | 0.7 | 0.1 |
| | | | | | | carbon | | | | | |
| Example 3 | 3.4 | 60.0 | 3.0 | 2.7 | 36.0 | Spherical | 0.1 | 2.8 | SBR | 1.0 | 0.2 |
| | | | | | | carbon | | | | | |
| Example 4 | 3.4 | 80.0 | 0.6 | 2.5 | 17.1 | Spherical | 0.1 | 2.1 | PVDF | 0.7 | 0.1 |
| | | | | | | carbon | | | | | |
| Comparative | 3.4 | 80.0 | 3.0 | 2.7 | 17.1 | Spherical | 0.1 | 2.1 | SBR | 0.7 | 0.1 |
| Example 1 | | | | | | carbon | | | | | |
| Comparative | 3.4 | 80.0 | 0.6 | 2.5 | 17.1 | Fibrous | 1.0 | 2.1 | SBR | 0.7 | 0.1 |
| Example 2 | | | | | | carbon | | | | | |
| Comparative | 3.4 | 80.0 | 1.1 | 13.6 | 17.1 | Spherical | 0.1 | 2.1 | SBR | 0.7 | 0.1 |
| Example 3 | | | | | | carbon | | | | | |

### [Evaluation]

Voronoi analysis of the positive electrode active material layers of the positive electrodes obtained in Examples 1 to 4 and Comparative Examples 1 to 3 and measurement of a diffusion resistance value of a secondary battery using the positive electrode were performed by the following method. A result is shown in Table 2 below together with the ratio of the average particle diameter of the conductive aid to the average particle diameter of the positive electrode active material (D50 of the conductive aid/D50 of the positive electrode active material) and the ratio of the average particle diameter of the solid electrolyte to the average particle diameter of the positive electrode active material (D50 of the solid electrolyte/D50 of the positive electrode active material).

### (Voronoi Analysis)

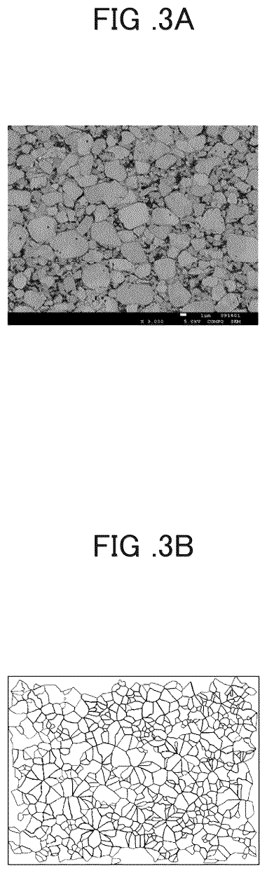

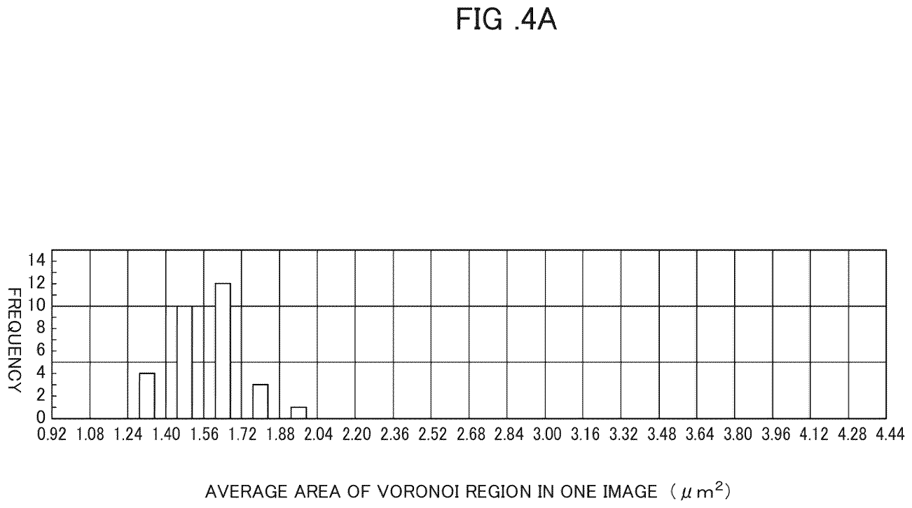

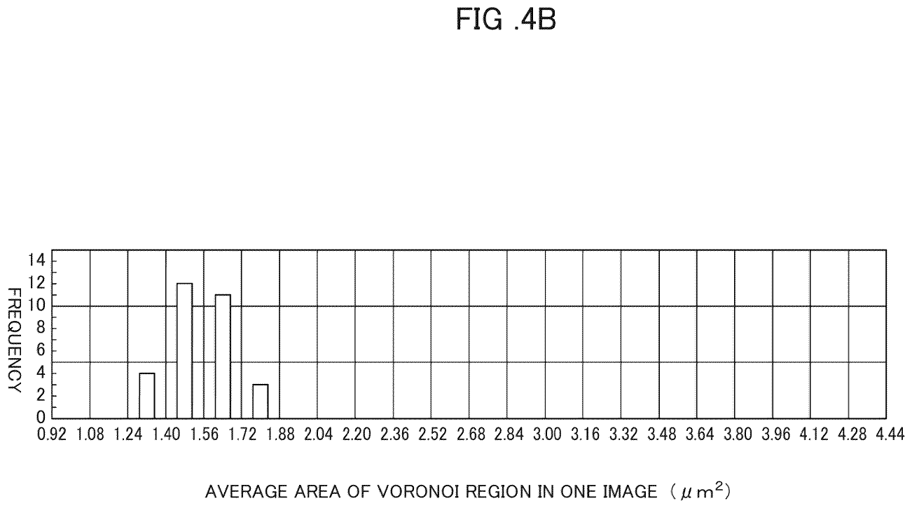

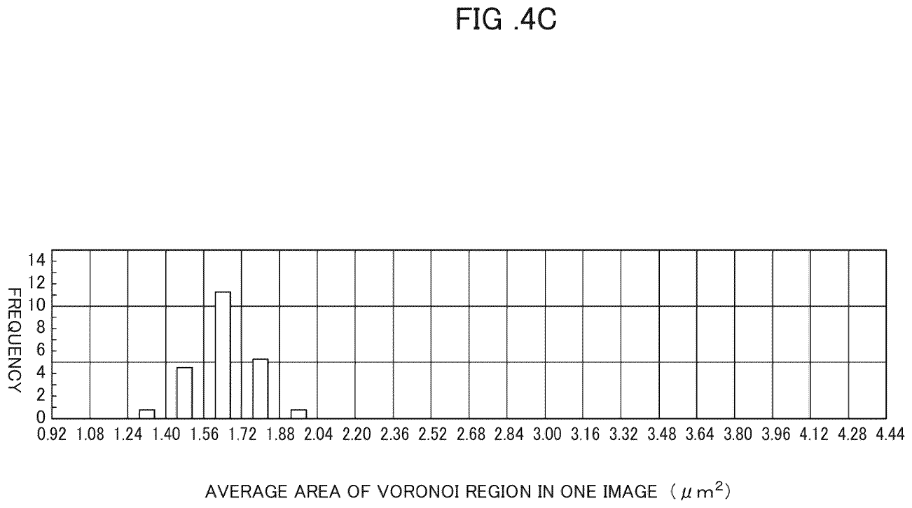

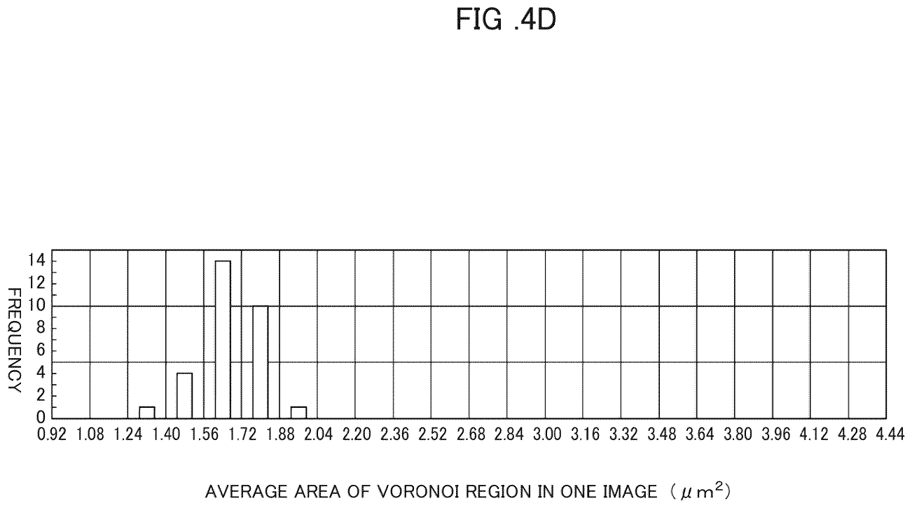

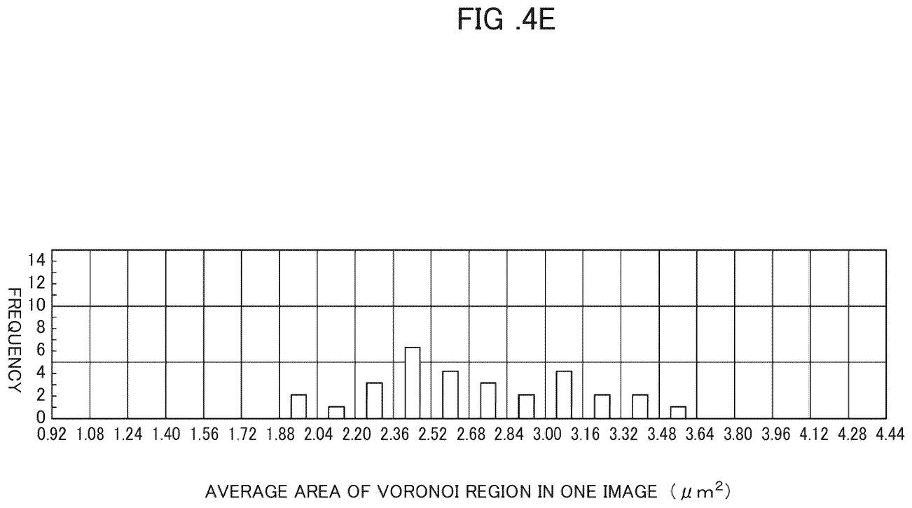

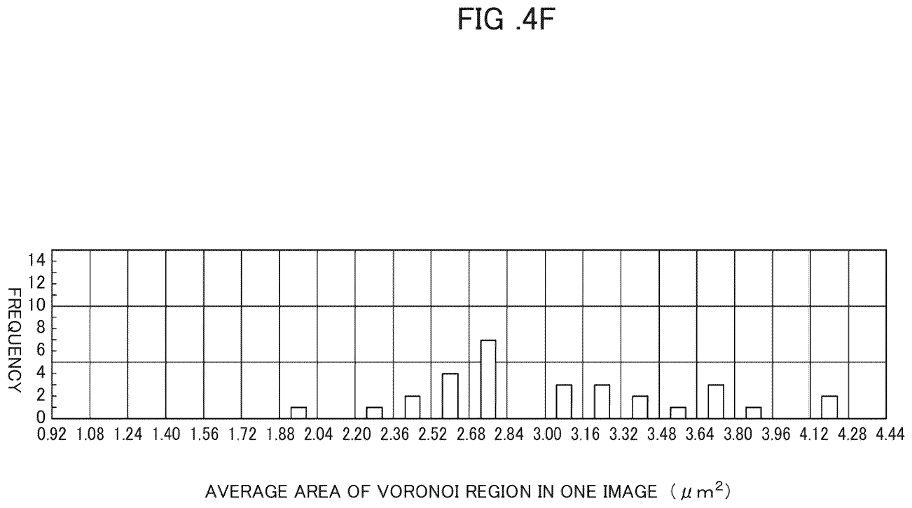

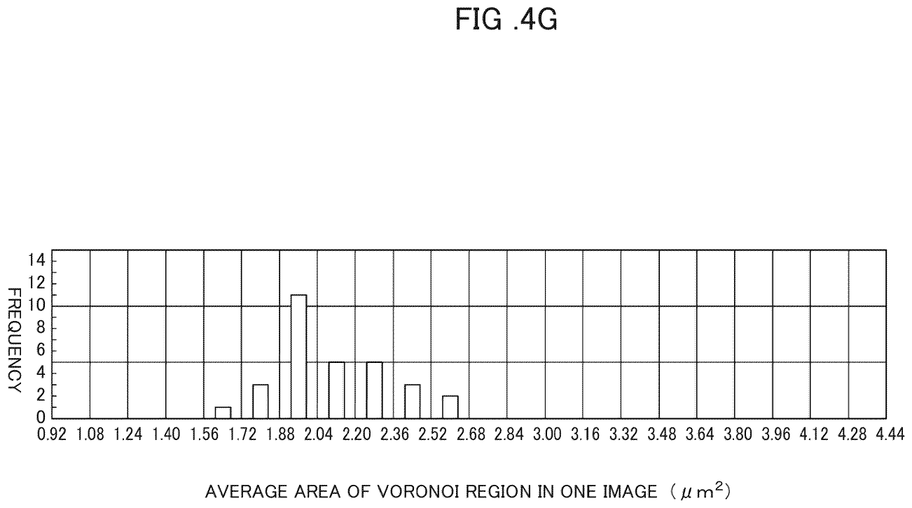

The positive electrodes obtained in Examples 1 to 4 and Comparative Examples 1 to 3 were cut in a thickness direction. A cut surface of the obtained positive electrode active material layer was observed using an FE-SEM (field emission scanning electron microscope JSM-7001F, manufactured by JEOL Ltd.) under a condition of a visual field area of 1044 μm² (29 μm long×36 μm wide, 3000 magnification). A reflected electron image of the positive electrode active material layer was subjected to Voronoi analysis using a conductive aid as a generatrix. The average area, the standard deviation, and the variation coefficient of Voronoi regions obtained by Voronoi analysis were calculated. The observation of the cut surface was performed at 30 positions, and the average area, the standard deviation, and the variation coefficient of the Voronoi region were calculated for each of the 30 positions. FIG. 3A illustrates an FE-SEM secondary electron image of the positive electrode active material obtained in Example 1, and FIG. 3B illustrates a Voronoi diagram of the positive electrode active material obtained in Example 1. FIGS. 4A to 4G illustrate frequency distribution of average areas of Voronoi regions using the conductive aid as the generatrix in one image measured at 30 positions of the cross sections of the positive electrode active material layers obtained in Examples 1 to 4 and Comparative Examples 1 to 3. Table 2 describes the average values of the average areas, the average values of the standard deviation, and the average values of the variation coefficients of the Voronoi regions measured at 30 positions.

### (Diffusion Resistance Value)

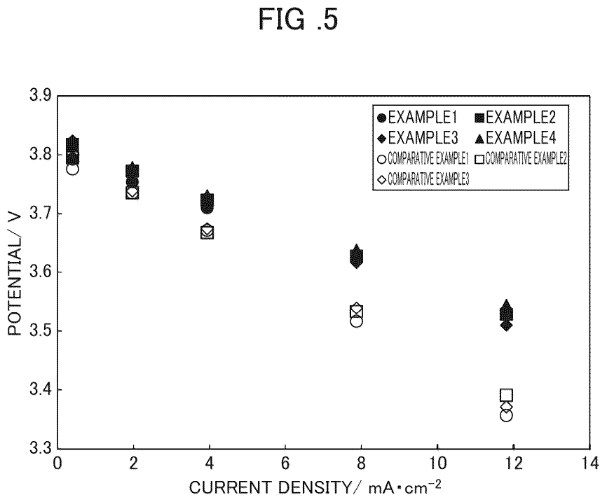

The solid electrolyte (100 mg) was weighed and applied at a molding pressure of 1.5 ton/cm² to obtain a solid electrolyte pellet. The positive electrodes obtained in Examples 1 to 4 and Comparative Examples 1 to 3 were disposed on one side of the solid electrolyte pellet, temporarily molded at 3.0 ton/cm², and then actually molded at an applied pressure of 10.0 ton/cm². A Li metal plate (1 mm thick) was disposed as a negative electrode on one surface of the solid electrolyte pellet opposite to the positive electrode side, and a molding pressure of 1.5 ton/cm² was applied to obtain a laminate in which the negative electrode, the solid electrolyte pellet, and the positive electrode were laminated in this order. After a terminal was attached to the positive electrode and the negative electrode of the obtained laminate via a lead wire, the laminate was accommodated in an outer case such that the terminal was exposed from the outer case, and the laminate was sealed to produce a solid-state battery. The produced solid-state battery was charged and discharged at a current density of 0.1 C (1 C=4.0 mA/cm²) under a confining pressure of 10 MPa and a test environment of 25° C. The solid-state battery after charging and discharging was charged again and discharged until a capacity reached 50% (SOC 50%) with respect to an initial discharge capacity, and then direct current resistance measurement and alternating current impedance measurement of the solid-state battery were performed. In the direct current resistance measurement, a current density (mA/cm²) and a potential (V) when discharged at current densities of 0.1 C, 0.5 C, 1.0 C, 2.0 C, and 3.0 C for 10 seconds were plotted to create an I-V characteristic graph, and a direct current resistance value was obtained from a slope of a plot of the I-V characteristic graph. FIG. 5 illustrates the I-V characteristic graph. In the alternating current impedance measurement, a solid electrolyte resistance value and a positive electrode reaction resistance value (charge transfer resistance value) were obtained from an amplitude of 1 Hz to 1 MHz at an alternating current voltage of 10 mV. A value obtained by subtracting the solid electrolyte resistance value and the positive electrode reaction resistance value obtained in the alternating current impedance measurement from the direct current resistance value obtained in the direct current resistance measurement was defined as a diffusion resistance value.

TABLE 2

| | | | Voronoi analysis | | | |
|---|---|---|---|---|---|---|
| | D50 of | D50 of solid | Average | Average | Average | |
| | conductive aid/ | electrolyte/ | value of | value of | value of | Diffusion |
| | D50 of positive | D50 of positive | average | standard | variation | resistance |
| | electrode | electrode | area | deviation | coefficient | value |
| | active material | active material | (μm²) | (μm²) | (%) | (Ω · cm²) |
| Example 1 | 0.03 | 0.74 | 1.66 | 0.142 | 8.6 | 4.9 |
| Example 2 | 0.03 | 0.88 | 1.63 | 0.136 | 8.4 | 5.5 |
| Example 3 | 0.03 | 0.79 | 1.72 | 0.134 | 7.8 | 4.7 |
| Example 4 | 0.03 | 0.74 | 1.76 | 0.139 | 7.9 | 3.7 |
| Comparative | 0.03 | 0.79 | 2.77 | 0.422 | 15.2 | 11.9 |
| Example 1 | | | | | | |
| Comparative | 0.29 | 0.74 | 3.13 | 0.557 | 17.8 | 14.6 |
| Example 2 | | | | | | |
| Comparative | 0.03 | 4.00 | 2.18 | 0.235 | 10.8 | 18.6 |
| Example 3 | | | | | | |

When FIGS. 4A to 4D are compared with FIGS. 4E to 4G, it is understood that a width of the frequency distribution of the average areas of the Voronoi regions of the positive electrode active material layers in Examples 1 to 4 is narrower than that of the frequency distribution of the average areas of the Voronoi regions of the positive electrode active material layers in Comparative Examples 1 to 3, and the variation of the average areas of the Voronoi regions is small.

From a result of Table 2, it is understood that the positive electrode active material layers in Examples 1 to 4 in which the average areas and the standard deviations of the Voronoi regions are within the range of the present invention have a smaller diffusion resistance value and more easily diffuse ions than the positive electrode active material layers in Comparative Examples 1 to 3 in which the average areas and the standard deviations of the Voronoi regions are larger than the range of the present invention. In addition, from the I-V characteristic graph of FIG. 5, it is understood that the operating voltage at a high current density is higher in the solid-state batteries produced using the positive electrodes obtained in Examples 1 to 4 than in the solid-state batteries produced using the positive electrodes obtained in Comparative Examples 1 to 3. This is because in the positive electrode active material layer of each of Examples 1 to 4, ions are easily diffused, and resistance does not increase easily even when discharged at a high current density.

### EXPLANATION OF REFERENCE NUMERALS

1 secondary battery
10 electrode laminate
20 positive electrode
21 positive electrode current collector
22 positive electrode active material layer
23 positive electrode lead wire
24 positive electrode terminal
30 negative electrode
31 negative electrode current collector
32 negative electrode active material layer
33 negative electrode lead wire
34 negative electrode terminal
36 lithium deposition layer
40 solid electrolyte layer
50 outer case
221 conductive aid
222 Voronoi region

What is claimed is:

1. A secondary battery electrode, comprising: a current collector; and an active material layer disposed on at least one surface of the current collector,
the active material layer containing an active material and a conductive aid,
an average value of areas of Voronoi regions obtained by performing Voronoi analysis on an image of a cross section using the conductive aid as a generatrix being within a range of 1.00 μm² or more and 2.50 μm² or less, a standard deviation of the areas of the Voronoi regions being 0.20 or less.

2. The secondary battery electrode according to claim 1, wherein a variation coefficient of the areas of the Voronoi regions is 10.0% or less.

3. The secondary battery electrode according to claim 1, wherein the conductive aid has a spherical shape, and
a ratio of an average particle diameter of the conductive aid measured by a laser diffraction method to an average particle diameter of the active material measured by the laser diffraction method is in a range of 0.010 or more and 0.080 or less.

4. The secondary battery electrode according to claim 1, further comprising: a solid electrolyte, wherein
a ratio of an average particle diameter of the solid electrolyte measured by a laser diffraction method to an average particle diameter of the active material measured by the laser diffraction method is in a range of 0.10 or more and 0.90 or less.

5. The secondary battery electrode according to claim 1, wherein an average particle diameter of the active material measured by a laser diffraction method is in a range of 1.0 μm or more and 5.0 μm or less.

6. The secondary battery electrode according to claim 1, wherein the secondary battery electrode is used as a positive electrode of a secondary battery.

7. A secondary battery comprising: the secondary battery electrode according to any one of claim 1.
